(19) United States
(12) Patent Application Publication
(10) Pub. No.: US 2007/0207075 A1
(43) Pub. Date: Sep. 6, 2007

(54) Separation of germanium-68 from gallium-68

(75) Inventor: Michael E. Fassbender, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/367,572

(22) Filed: Mar. 3, 2006

(51) Int. Cl. C01F 13/00

(52) U.S. Cl. 423/2

(57) ABSTRACT

A method for separating germanium-68 from gallium-68 using an anion exchange resin and a chelating/complexing agent containing a plurality of carboxylic acid groups and at least three carbon atoms to the first solution is disclosed together with a generator apparatus for providing a source of gallium-68.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to isotopic separation and more particularly to a method for separating germanium-68 (Ge-68) from gallium-68 (Ga-68).

### BACKGROUND OF THE INVENTION

Germanium-68 is a radionuclide generator parent that decays to gallium-68. Gallium-68 is a positron emitting radionuclide that finds extensive use in calibration procedures for positron emission tomography detectors. Gallium-68 has also been proposed as a nuclide for use with in vivo imaging studies in patients.

A germanium-68/gallium-68 generator system would be desirable in producing a supply of gallium-68 for its use as a positron emitter. To obtain the germanium-68 in a form suitable to yield the desired output of gallium-68, the germanium-68 must first be produced and then separated from other gallium species so as to yield a high specific activity gallium-68 product.

One current method in use involves liquid-liquid extraction of germanium in the form of highly volatile germanium tetrachloride (GeCl₄). The extraction is performed using carbon tetrachloride, which is toxic, teratogenic and carcinogenic and poses a significant health hazard. Another published method utilizes oxalic acid as chelating/complexing agent. Oxalic acid too poses a health hazard. Furthermore, the use of oxalic acid requires much higher acid concentrations both with column feed and subsequent gallium elution.

There remains a need for a better method for separating germanium-68 from gallium-68 and a need for a better germanium-68/gallium-68 generator system.

### SUMMARY OF THE INVENTION

In accordance with the purposes of the present invention, as embodied and broadly described herein, the present invention includes a method for separating germanium-68 from gallium-68 including dissolving an irradiated gallium metal target in a nitric acid solution including a minor portion of sulfuric acid sufficient to convert gallium nitrate (Ga(NO₃)₃) to gallium sulfate (Ga₂(SO₄)₃) and thereafter evaporating the solution to dryness whereby residual solids remain, dissolving the residual solids in water to form a first solution and adding a pre-determined amount of a chelating/complexing agent containing a plurality of carboxylic acid groups and at least three carbon atoms to the first solution, adjusting the pH of the first solution to a range from about 0.9-1.1 by addition of a mineral acid, contacting the first solution with an anion exchange resin capable of selectively retaining primarily germanium metal ions, the germanium metal ions being predominantly germanium-68, and, separating the germanium-68 metal ions from the anion exchange resin. The method can further include contacting the separated germanium-68 metal ions with an anion exchange resin column including from about 2 to about 3 ml of anion exchange resin.

The present invention further includes a germanium-68/gallium-68 generator system or generator apparatus for providing a source of gallium-68, the apparatus including an anion exchange resin including a germanium-68 citrate complex thereon, a reservoir for holding a stock solution therein, and, transport means for passing a portion of the stock solution across the anion exchange resin including a germanium-68 citrate complex whereby a pre-determined portion of the daughter gallium-68 product is separated from the anion exchange resin. Preferably, the gallium-68 product has a high specific activity.

### BRIEF DESCRIPTION OF THE DRAWINGS

FIG. 1 shows a schematic representation of a generator apparatus in accordance with the present invention for providing gallium-68.

### DETAILED DESCRIPTION

The invention is concerned with recovering radionuclide germanium-68 with high specific activity from gallium metal that has been irradiated with a beam of charged particles. The invention is also concerned with a portable generator system for separating germanium-68 from gallium-68, i.e., the generation of a gallium-68 daughter product.

The method of the invention is advantageous over existing methods because (1) the radiochemical yield is higher with no significant losses due to volatilization; and (2) all of the reagents used in the procedure are non-toxic in the sense that they can be neutralized to non-toxic salts. The solutions involving anion exchange contain mineral acids in low concentrations (0.1-0.5 molar), ensuring a low hazard and a longer shelf life of the germanium-68 loaded resin.

The method of the invention can be used by companies having a small, low energy cyclotron with the intent of producing germanium-68 on a regular basis thereby allowing a steady yield of the daughter product of gallium-68. Furthermore, the invention may be used in order to manufacture a portable germanium-68/gallium-68 radionuclide generator system for the convenient supply of short-lived ⁶⁸gallium citrate on site of nuclear medical facilities.

In the present invention, a gallium metal target can be irradiated by a low-energy beam from a low energy cyclotron. Such instruments are commonly available and can allow wide availability of the process and generator of the present invention. The energy level of such a cyclotron is generally in the range of about 30 to about 100 MeV. Irradiation of a gallium metal target can generally be accomplished in a period of time of about a week or more.

Following irradiation of a suitable gallium metal target, separation of the germanium-68 begins by dissolution of the irradiated gallium metal target. Such dissolution can be accomplished by use of any mineral acid, preferably using a strong nitric acid solution including a minor portion of sulfuric acid sufficient to convert gallium nitrate to gallium sulfate. Generally, the nitric acid solution will be at concentrations from about 1M to 16M, preferably around about 11 M. Thereafter the resultant solution can be evaporated to dryness whereby residual solids remain. Usually one or more re-dissolution and re-evaporation steps can be employed for better cleanup of the materials.

Eventually, the remaining residual solids are dissolved in water to form a first solution and a pre-determined amount of a chelating/complexing agent can be added to the first solution. The chelating/complexing agent includes a plurality of carboxylic acid groups and at least three carbon atoms and can be a variety of materials including citric acid, tartaric acid, malonic acid, malic acid and succinic acid. Preferably, the chelating/complexing agent is preferably citric acid. In some instances, the chelating/complexing agent may includes a plurality of other electron donor groups such as amino groups, hydroxyl groups or thiol groups and among suitable materials within those categories may be included urea.

The pH of the first solution is then adjusted to within a range from about 0 to about 4, preferably from about 0.9 to about 1.1, by addition of a mineral acid, preferably nitric acid. Then, the first solution is contacted with an anion exchange resin capable of selectively retaining primarily germanium metal ions, the germanium metal ions being predominantly germanium-68, and then separating the captured germanium-68 metal ions from the anion exchange resin.

The method can further include contacting the separated germanium-68 metal ions with an anion exchange resin column including from about 2 ml to about 3 ml of anion exchange resin whereby the small amount of anion exchange resin retains the germanium-68 metal ions. In this manner, the anion exchange material is thus loaded with germanium-68 metal ions and the loaded anion exchange material can be utilized as a germanium-68/gallium-68 generator system.

Gallium-68 can be eluted from the generator system as needed by contact with small amounts of a 0.1 M sulfuric acid and 0.25 M citric acid solution.

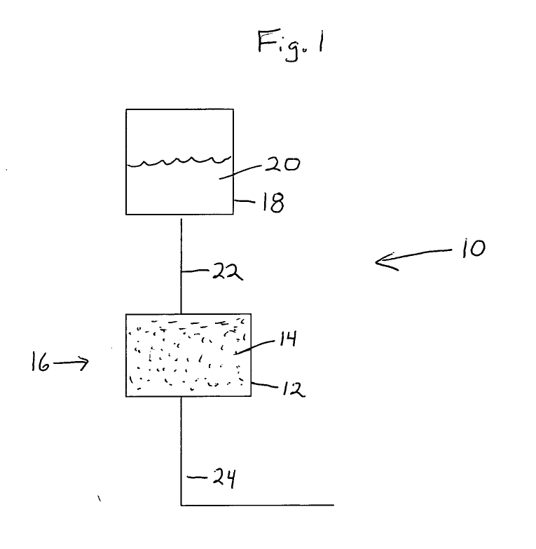

FIG. 1 illustrates a generator apparatus useful in providing a source of gallium-68. Generator apparatus 10 includes a container 12 that holds anion exchange resin 14 loaded with germanium-68 citrate complex. Container 12 and resin 14 make up bed 16. Container 18 holds eluant solution 20, generally a 0.1 M sulfuric acid and 0.25 M citric acid solution. Conduit 22 passes the solution 20 to bed 16 and the desired product is exited through product conduit 24 for use.

The present invention is more particularly described in the following example which is intended as illustrative only, since numerous modifications and variations will be apparent to those skilled in the art.

### EXAMPLE

Gallium metal (5.0 grams) was irradiated with a beam of charged particles and then dissolved in nitric acid (11 molar). Concentrated sulfuric acid (5.5 milliliters, about 96 to 98 percent) was added to the solution, and the resulting solution was evaporated to dryness. The resulting salt cake was dissolved in water and then evaporated to dryness. The residue was dissolved in water, and anhydrous citric acid (4.8 grams) was added to the solution. The resulting solution was acidified with sulfuric acid to provide a pH of about 0.9 to 1.1. The resulting pH adjusted solution was loaded on a column of anion exchanger resin Ag 1×8 (6 ml resin bed). The resin bed retained the germanium, while gallium (and longer lived radioisotopes such as zinc-65) were eluted. The exchanger column was washed with an aqueous solution of 0.25 molar citric acid and 0.1 molar sulfuric acid (4×20 milliliters). Afterward, the exchanger column was washed with water (2 ×20 milliliters). Subsequently, germanium-68 activity was stripped from the column with fractions (3 milliliters) of nitric acid (0.5 molar). Fractions containing germanium-68 activity were combined and then evaporated to dryness. The resulting residue was taken up in a volume (<10 milliliters) of an aqueous solution of citric acid (0.25 molar) and sulfuric acid (0.1 molar). The process was repeated using a small anion exchanger column.

Although the present invention has been described with reference to specific details, it is not intended that such details should be regarded as limitations upon the scope of the invention, except as and to the extent that they are included in the accompanying claims.

What is claimed is:

1. A method for separating germanium-68 from gallium-68 comprising:
dissolving an irradiated gallium metal target in a nitric acid solution including a minor portion of sulfuric acid sufficient to convert gallium nitrate to gallium sulfate and thereafter evaporating the solution to dryness whereby residual solids remain;
dissolving the residual solids in water to form a first solution and adding a pre-determined amount of a chelating/complexing agent containing a plurality of carboxylic acid groups and at least three carbon atoms to the first solution;
adjusting the pH of the first solution to a range from about 0.9-1.1 by addition of a mineral acid; and,
contacting the first solution with an anion exchange resin capable of selectively retaining primarily germanium metal ions, the germanium metal ions being predominantly germanium-68.

2. The method of claim 1 further including separating the germanium-68 metal ions from the anion exchange resin.

3. The method of claim 2 further including contacting the separated germanium-68 metal ions with an anion exchange resin column including from about 2 ml to about 3 ml of anion exchange resin.

4. The method of claim 1 wherein the chelating/complexing agent is selected from the group consisting of citric acid, tartaric acid, malonic acid, malic acid and succinic acid.

5. The method of claim 1 wherein the chelating/complexing agent is citric acid.

6. The method of claim 2 wherein the chelating/complexing agent is selected from the group consisting of citric acid, tartaric acid, malonic acid, malic acid and succinic acid.

7. The method of claim 2 wherein the chelating/complexing agent is citric acid.

8. A generator apparatus for providing a source of gallium-68, the apparatus comprising:
an anion exchange resin including a germanium-68 citrate anionic complex thereon;
a reservoir for holding a stock solution therein; and,
transport means for passing a portion of the stock solution across the anion exchange resin including a germanium-68 citrate complex whereby a pre-determined portion of gallium-68 is separated from the anion exchange resin.

9. The generator apparatus of claim 8 wherein the stock solution is an about 0.1 M sulfuric acid and about 0.25 M citric acid solution.
